(19) United States
(12) Patent Application Publication
(10) Pub. No.: US 2011/0135326 A1
(43) Pub. Date: Jun. 9, 2011

(54) PRINTING APPARATUS, METHOD OF CONTROLLING PRINTING APPARATUS, AND PROGRAM

(75) Inventor: Makoto Anno, Tokyo (JP)

(73) Assignee: CANON KABUSHIKI KAISHA, Tokyo (JP)

(21) Appl. No.: 12/959,623

(22) Filed: Dec. 3, 2010

(30) Foreign Application Priority Data
Dec. 8, 2009 (JP) PCT/JP2009/070573

(51) Int. Cl. G03G 15/00

(52) U.S. Cl. 399/21

(57) ABSTRACT

When an interrupted printing process is to be restarted, normally printed sheets can be reused. When jamming of a sheet is detected while a job is being performed, the printing is interrupted and specification of one or more sheets among the sheets that have been fed from the feeding unit before the job was interrupted is accepted from a user. Furthermore, a feeding unit in which the specified sheet is set so as to be reused by the user is selected. Then, when the printing is to be restarted, control is performed so that one or more sheets that have been specified are not reprinted, the specified sheets being fed from the selected feeding unit and being output together with the sheet to be reprinted.

### TECHNICAL FIELD

The present invention relates to a printing apparatus, a method of controlling the printing apparatus, and a program.

### BACKGROUND ART

In printing apparatuses, when jamming occurs in a sheet transport path, printing is interrupted, and the transport of a sheet is stopped, thereby preventing the jamming situation from becoming worse.

In order to restart interrupted printing, a user removes a sheet that exists in the sheet transport path of the printing apparatus and confirms that all the sheets have been removed, and thereafter, instructs the restarting of the printing. When the printing apparatus is instructed to restart printing, a new sheet is fed from a sheet feeding unit, and printing is restarted.

As a method for instructing the restarting of printing, PTL 1 proposes a method in which thumbnails of images to be printed are displayed on an operation screen, and printing is restarted from the image selected by a user (see PTL 1).

### CITATION LIST

### Patent Literature

PTL 1 Japanese Patent Laid-Open No. 2006-272904

### TECHNICAL PROBLEM

However, in the printing restarting method of the related art, it is not possible for a user to reuse a sheet removed from a sheet transport path in a printing process to be restarted. For example, among sheets that are removed from the sheet transport path, some sheets have no folds or wrinkles, and can be handled as normal output matter. Even if there are such sheets, it has not been possible to use them as normal output matter.

In the case of the method disclosed in PTL 1, as a result of restarting printing from an image selected by the user, it is not necessary to preprint images preceding the selected image. However, since the selected image and all images subsequent thereto are printed again, it has not been possible to reuse sheets of and subsequent to the selected image, on which an image has already been printed.

The present invention has been achieved to solve the above-mentioned problems. The present invention provides a scheme with which normally printed sheets can be reused when restarting interrupted printing.

### SUMMARY OF INVENTION

The present invention provides an apparatus that feeds a sheet from one feeding unit among a plurality of feeding units and that performs printing on the fed sheet, the apparatus including: an interruption unit configured to interrupt printing when jamming of a sheet is detected; a reprinting unit configured to, after printing is interrupted, perform reprinting on the sheet that is fed when restarting the printing; a specification unit configured to, when the printing is interrupted, specify one or more sheets among the sheets that have been fed before the job was interrupted; a selection unit configured to select a feeding unit among the plurality of feeding units, in which specified sheets are set so that the user reuses the sheets; and a control unit configured to, when restarting the printing, perform control so that reprinting is not performed on the one or more specified sheets, the specified sheets being fed from the selected feeding unit and being output together with the sheet on which reprinting is performed.

Further features of the present invention will become apparent from the following description of exemplary embodiments with reference to the attached drawings.

### BRIEF DESCRIPTION OF DRAWINGS

FIG. 1 is a block diagram showing the configuration of a printing system according to the present invention.

FIG. 2 is a cross-sectional view showing the configuration of the printing system according to the present invention.

FIG. 3 is a flowchart illustrating a procedure of a printing process in a control unit of the present invention.

FIG. 4 is a flowchart illustrating a procedure of a printing process in the control unit of the present invention.

FIG. 5 is a flowchart illustrating a process when jamming occurs in the control unit of the present invention.

FIG. 6 is a flowchart illustrating a process for specifying a page to be reused in the control unit of the present invention.

FIG. 7 is a flowchart illustrating a procedure of a reprinting process in the control unit of the present invention.

FIG. 8 illustrates an example of a display screen displayed on an operation unit according to the present invention.

FIG. 9 illustrates an example of a display screen displayed on the operation unit according to the present invention.

FIG. 10 is a flowchart illustrating a process for specifying a page to be reused in the control unit according to the present invention.

FIG. 11 illustrates an example of a display screen displayed on the operation unit according to the present invention.

FIG. 12 illustrates an example of a display screen displayed on the operation unit according to the present invention.

FIG. 13 is a flowchart illustrating a procedure of a process for counting sheets in the control unit according to the present invention.

FIG. 14 illustrates the structure of a job according to the present invention.

FIG. 15 illustrates an example of the transport situation of sheets according to the present invention.

### DESCRIPTION OF EMBODIMENTS

### First Embodiment

Hereinafter, best modes for carrying out the invention will be described with reference to the drawings.

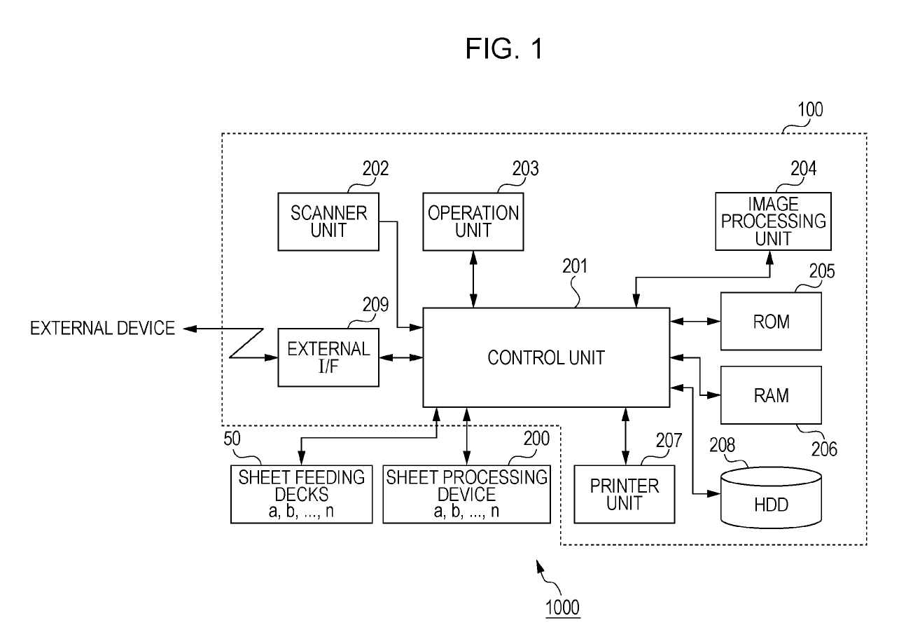

FIG. 1 is a block diagram showing the configuration of a printing system 1000 according to an embodiment of the present invention. The printing system 1000 includes a sheet feeding deck 50, a printing apparatus 100, and a sheet processing device 200.

The sheet feeding deck 50 is connected to the printing apparatus 100 and supplies sheets used for printing to the printing apparatus. The printing apparatus 100 performs printing on fed sheets. The sheet processing device 200 performs sheet processing, such as a stapling process, a punching process, and a bookbinding process, on a sheet printed by the printing apparatus 100, and ejects the sheet on which the sheet processing has been performed.

The printing apparatus 100 includes a control unit 201, a scanner unit 202, an operation unit 203, and a compression and decompression unit 204, a ROM 205, a RAM 206, a printer unit 207, an HDD 208, and an external I/F unit 209. These are interconnected with one another through an interface, such as a bus, so as to be mutually communicable with one another.

The control unit 201 includes a microcomputer, and centrally controls the printing system 1000.

The ROM 205 has stored therein a program to be read and executed by the control unit 201. The RAM 206 is used as an operation area of the control unit 201.

The operation unit 203, which includes a liquid-crystal display unit and a touch panel, accepts instructions from a user, and displays a message for the user.

The scanner unit 202 reads a document, and generates image data of the read document. The printer unit 207 prints an image on the basis of the image data. The external I/F 209 is an interface for receiving printing data (for example, PDL data) and various commands from a personal computer (PC) and a print server.

The image data processing unit 204 performs an image data compression and decompression process and image data format conversion in accordance with instructions from the control unit 201. Furthermore, on the basis of the image data, the image data processing unit 204 has a function of generating a thumbnail image in which the size of the image data is reduced.

The HDD 208 stores image data generated by reading the document using the scanner unit 202, printing data that is accepted from an external device, such as a PC, via the external I/F 209, and a thumbnail image generated by the image data processing unit 204.

The printing system 1000 has a configuration such as that described above. In such a printing system 1000, the microcomputer of the control unit 201 reads a program stored in the ROM 205 and executes it, thereby performing various jobs, such as a copy job and a print job. The copy job is a job in which an image based on the image data generated by reading a document by using the scanner unit 202 is printed on a sheet by the printer unit 207 on the basis of the setting accepted from the operation unit 203. The print job is a job in which an image based on the printing data accepted via the external I/F 209 is printed on a sheet by using the printer unit 207 in accordance with printing setting accepted similarly via the external I/F unit 209.

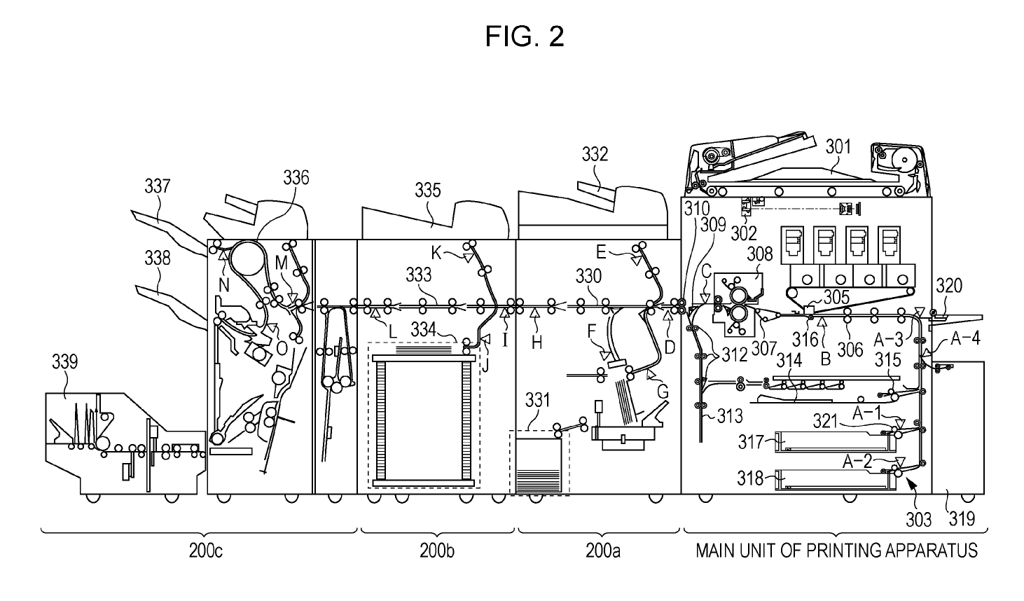

Next, the configuration of the printing system 1000 will be described with reference to a cross-sectional view shown in FIG. 2. Here, the configuration will be described together with the operation performed when a copy job is performed.

An automatic document feeder (ADF) 301 provided in the scanner unit 202 sequentially separates a plurality of sheets that are set on a document tray by the user starting from the first sheet, and transports them onto a document glass plate. A reading unit 302 reads the image of the document transported onto the document glass plate by using CCDs, and converts the image into image data. The converted image data is stored in the memory, such as the RAM 206 and the HDD 208, by the control unit 201.

The printing apparatus 100 has a color printer configuration of a tandem type including a plurality of photosensitive bodies (drums), includes sheet feeding units, such as sheet feeding cassettes 317 and 318 and a manual bypass tray 320, and feeds sheets from one of the sheet feeding units. Furthermore, a sheet feeding deck 319 capable of housing a large number of sheets is also connected as a sheet feeding unit to the printing apparatus 100, so that sheets can be fed from the sheet feeding deck 319. The printing apparatus 100 temporarily stops operating when the sheet that is fed from one of the sheet feeding units is transported to resist rollers 306 so that synchronization with an intermediate transfer belt 305 is achieved. Furthermore, when a sheet waiting for transfer exists at the position of the resist rollers 306, a sheet on which the next page is to be printed can be fed from one of the sheet feeding cassettes 317 and 318, the sheet feeding deck 319, and the manual bypass tray 320. As a result of performing sheet feeding in the manner described above, it is possible to shorten intervals at which a plurality of sheets are transported, and the printing productivity can be increased.

The image data that is temporarily stored in the RAM 206 and the HDD 208 is transferred to the printer unit 207, and the image data is converted into respective recording laser light of yellow (Y), magenta (M), cyan (C), and black (K) in a laser recording unit (not shown). Then, the recording laser light is radiated to the photosensitive body of each color, and an electrostatic latent image corresponding to each color is formed on the photosensitive bodies. Then, toner development is performed using toner of four colors supplied from toner cartridges, and a toner image that is made visible is temporarily transferred from the photosensitive bodies to the intermediate transfer belt 305.

The intermediate transfer belt 305 rotates at a constant speed in the clockwise direction in the figure. Then, when the intermediate transfer belt 305 is rotated to a predetermined position, the transport of the sheet during standby at the position of the resist rollers 306 is started. Here, the predetermined position is a position at which, when the leading end of the image transferred onto the intermediate transfer belt 305 reaches a secondary transfer position 316, the almost leading end of the sheet is transported to the secondary transfer position. In this manner, at the secondary transfer position 316, the toner image on the intermediate transfer belt 305 is transferred to the sheet.

The sheet to which the toner image has been transferred is further transported by the belt 307, and the toner is fixed by application of pressure and heat from the fixing unit 308. After the sheet is transported through the sheet transport path, the sheet is ejected.

A paper ejection flapper 309 is configured in such a manner as to be swingable about the swing axis, so that the transport direction of a sheet is specified. When the paper ejection flapper 309 swings in the clockwise direction in the figure and is fixed at the position shown, the sheet ejected from the fixing unit 308 is directly transported in the lateral direction, and is transported to a starching bookbinding machine 200a, which is one of sheet processing devices 200, by the paper ejection rollers 310. In the manner described above, one-side printing is performed.

On the other hand, when an image is to be printed on both sides of a sheet, the paper ejection flapper 309 swings in the counterclockwise direction in the figure and is fixed at the position shown. The course of the sheet ejected from the fixing unit 308 is changed to a downward direction, and the sheet is sent to a double-sided transport unit. The double-sided transport unit includes a reverse flapper 311, inversion rollers 312, an inversion guide 313, and a double-sided tray 314. The reverse flapper 311 swings about the swing axis so as to specify the sheet transport direction. When double-sided printing is to be performed, the control unit 201 performs control so that the reverse flapper 311 is caused to swing in the counterclockwise direction in the figure, and a sheet having an image printed on its first surface is sent to the inversion guide 313 via the transport rollers 312. Then, the inversion rollers are temporarily stopped in a state in which the trailing end of the sheet is grasped between the inversion rollers provided in the entry of the inversion guide. Then, the reverse flapper 311 is made to swing in the clockwise direction so that the inversion rollers are rotated in the opposite direction, as shown in the figure. As a result, control is performed so that the sheet is made to switch back and transported, and the sheet is guided to the double-sided tray 314 in a state in which the trailing end and the leading end of the sheet are swapped over.

The sheet is temporarily placed in the double-sided tray 314. After that, the sheet is sent again to the resist rollers 306 by sheet refeeding rollers 315. At this time, the sheet is sent in a state in which a second surface thereof reverse to the surface onto which toner has been transferred in the transfer process for the first surface opposedly faces the intermediate transfer belt 305. Then, similarly to the transfer process for the first surface, an image is formed on the second surface of the sheet. The image formed on the second surface of the sheet is then fixed by the fixing unit 308. After that, the sheet having the image formed thereon is transported to a starching bookbinding machine 200a, which is one of the sheet processing devices 200, by the paper ejection rollers 310. In the manner described above, double-sided printing is performed.

The sheet having an image printed on one side or both sides thereof by the printing apparatus 100 is selectively transported to the starching bookbinding machine 200a, a large capacity stacker 200b, or a saddle-stitching machine 200c, which is the sheet processing device 200, in accordance with the printing setting from the operation unit 203.

When it is set that starching bookbinding be performed, the sheet is transported to the starching bookbinding machine 200a. After a bookbinding process is performed thereon, the sheet is ejected onto a bookbound matter ejection unit 331. That is, in the bookbinding process, a plurality of sheets on which an image has been printed by the printing apparatus 100 is bound in such a manner as to be wrapped by a sheet fed from an inserter 332 as necessary. The bookbound printed matter is accumulated in the bookbound matter ejection unit 331.

Furthermore, in a case where a mass accumulation process is to be performed, the sheet on which an image has been printed by the printing apparatus 100 is transported to the large capacity stacker 200b via the sheet transport path 330 of the starching bookbinding machine 200a. The large capacity stacker 200b ejects the received sheet onto an escape tray 335 or an accumulation unit 334.

In a case where a post-process has not been set, the sheet having an image printed by the printing apparatus 100 is transported to the saddle-stitching machine 200c via the sheet transport path 330 of the starching bookbinding machine 200a and a sheet transport path 333 of the large capacity stacker 200b. The saddle-stitching machine 200c ejects the received sheet onto a paper ejection unit 337 via a sheet transport path 336.

Furthermore, in a case where a stapling process is set to be performed, the saddle-stitching machine 200c accumulates the received sheet in an intermediate tray via the sheet transport path 336. Then, at the stage where a bundle of sheets to be stapled are complete in the intermediate tray, the saddle-stitching machine 200c staples the bundle of sheets and ejects them onto the paper ejection unit 338.

Furthermore, in a case where a saddle-stitching process is set to be performed, the saddle-stitching machine 200c performs a saddle-stitching process on the received sheet, and ejects it onto the paper ejection unit 339.

As described above, in the printing system 1000, processing, such as sheet feeding, printing, post-processing, and paper ejection, is performed.

In the printing system 1000, the sheet transport path possessed by each of the printing apparatus 100, the starching bookbinding machine 200a, the large capacity stacker 200b, and the saddle-stitching machine 200c is provided with a sheet detection sensor. More specifically, the sheet detection sensor is provided in an entry/exit of each device, branching points and merging points of sheet transport paths, etc. FIG. 2 shows examples of positions at which sheet detection sensors are provided by using triangular symbols, and A to O each represent a sheet detection sensor. By receiving signals from these sheet detection sensors, the control unit 201 detects the presence or absence of a sheet transported via the sheet transport paths, and the position of the sheet.

Furthermore, for example, in a case where a signal from a certain sheet detection sensor continues for a predetermined time period or more, the control unit 201 determines that staying jamming of a sheet has occurred at the position corresponding to the sensor from which the signal has been continuously transmitted. Alternatively, in a case where a sheet that has passed through a certain sheet detection sensor does not pass through the next sheet detection sensor for a predetermined time period or more, the control unit 201 determines that delay jamming (jam) has occurred between those sheet detection sensors.

Then, when jamming of the sheet has occurred in the sheet transport path of the printing system 1000, the control unit 201 interrupts the printing, and displays the position of the sheet to be removed and the removal procedure as s guidance in accordance with the signal from the sheet detection sensor. As a result, the user understands where in the printing system 1000, a sheet to be removed exists, opens the door of the device, and removes the sheet from the sheet transport path in accordance with the guidance. When all the sheets are removed, the user instructs the restarting of the printing via the operation unit 203. When the control unit 201 receives the instruction of the restarting of the printing, the control unit 201 restarts the printing. In the present embodiment, it is assumed that the restarting of the printing is performed starting from the sheet that has not been normally ejected when the printing was interrupted.

Furthermore, the sheet feeding openings of the sheet feeding units of the sheet feeding cassettes 317 and 318, the sheet feeding deck 319, and the manual bypass tray 320 are provided with sheet detection sensors A-1, A-2, A-4, and A-3 serving as sheet feeding sensors, respectively. These sheet feeding sensors detect the fed sheet, and transmit a sheet detection signal to the control unit 201. The control unit 201 counts the number of sheets fed from each sheet feeding unit in accordance with the sheet detection signal received from the sheet feeding sensor. The control unit 201 holds the counted value in the RAM 206. As a result, it is possible for the control unit 201 to know the number of sheets fed from the respective sheet feeding units.

Furthermore, the paper ejection unit 337 of the saddle-stitching machine 200c is provided with a paper ejection sensor N. The paper ejection sensor N detects the sheet ejected onto the paper ejection unit 337 and transmits a sheet paper ejection signal to the control unit 201. The control unit 201 counts the number of ejected sheets in accordance with the sheet paper ejection signal. The control unit 201 holds the counted value in the RAM 206. As a result, it is possible for the control unit 201 to know the number of sheets ejected onto the paper ejection unit 337.

In the present embodiment, a description will be given of a case in which the printing apparatus 100 is a 4D (drum)-type color MFP. However, the configuration of the printing apparatus 100 is not limited to this, and a monochrome MFP or a 1D (drum)-type color MFP may be used. Furthermore, in the foregoing, the operation and the configuration have been described by using a copy job as an example. In the print job, printing data from the external I/F is used in place of the image data from the scanner unit, and identical printing operation is performed in the present configuration.

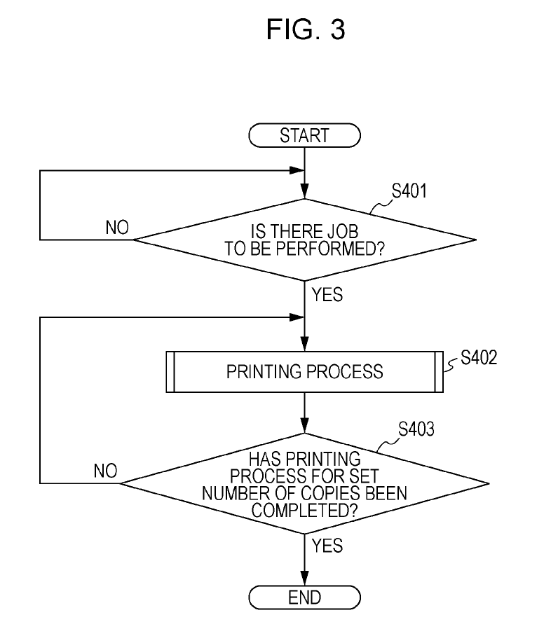

Next, a description will be given, with reference to FIG. 3, of a processing procedure in the printing system 1000 in the present embodiment. Each step of the flowchart shown in FIG. 3 is realized by reading and executing a program stored in the ROM 205 by the microcomputer of the control unit 201.

Initially, in S401, the control unit 201 determines whether or not there is a job to be performed by referring to the HDD 208.

Examples of jobs to be performed include a copy job and a print job. When a copy job is to be performed, the control unit 201 causes the scanner unit 202 to read a document when a start key provided in the operation unit 203 is pressed. Then, the control unit 201 stores, as a copy job, the image data of the read document and the copy setting accepted via the operation unit 203 in the HDD 208. Furthermore, when the image data and the printing setting are received via the external I/F unit 209, the control unit 201 stores them as a print job in the HDD 208 in such a manner that the image data and the printing setting are associated with each other. The type of the job is not limited to this, and may be a box print job in which the job stored in the HDD 208 in advance is selected by the user, or a fax reception job in which fax-received image data is printed.

When the control unit 201 determines that there is a job to be performed in the HDD 208, the process proceeds to S402, and when the control unit 201 determines that there is no job to be performed, the process of S401 is repeated.

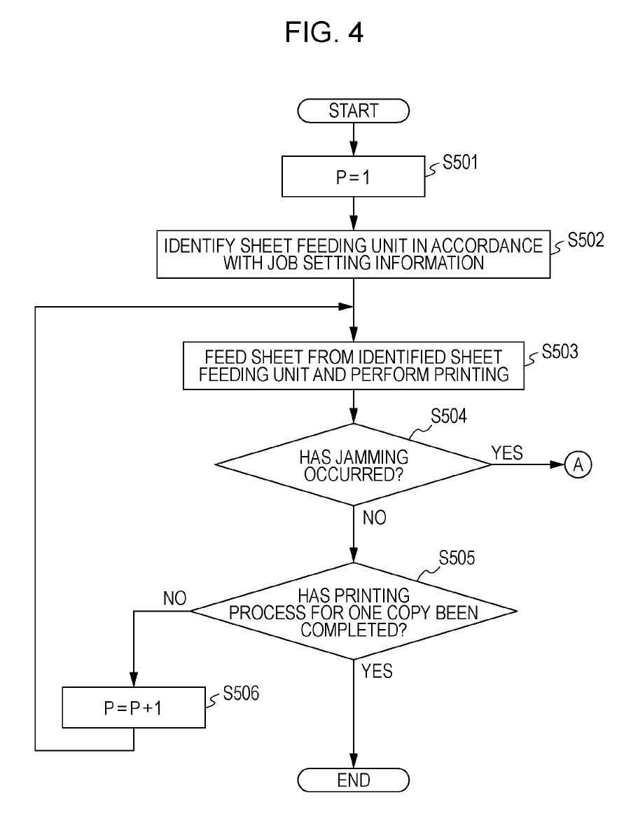

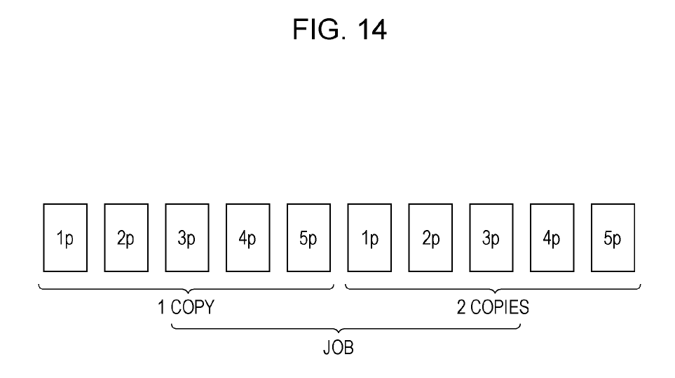

In S402, by performing the job stored in the HDD 208, the control unit 201 performs a printing process for one copy that is printed by performing the job. The details of the printing process performed in S402 will be described later with reference to FIG. 4. Here, the relationship between jobs and the number of pages will be described with reference to FIG. 14. In the case of the figure shown in FIG. 14, the job is set in such a manner that one copy is composed of five pages, and two copies are printed. Of course, the number of copies and the number of pages contained in the job are not limited to these. In the case that the job is structured as shown in FIG. 14, in S402, the control unit 201 performs a printing process for one to five pages.

When the printing process for one copy is completed, in S403, the control unit 201 determines whether or not the printing process for the number of copies, which is set in the job, has been completed. In the case of the example shown in FIG. 14, the control unit 201 determines whether or not a printing process for two copies has been completed. When the printing process has not been completed, the process returns to S402, and when the printing process for the set number of copies has been completed, the processing is completed.

FIG. 4 is a flowchart illustrating a printing process for one copy, which is performed by the control unit 201 in S402 shown in FIG. 3. Each step of the flowchart shown in FIG. 4 is realized by reading and executing a program stored in the ROM 205 by the microcomputer of the control unit 201.

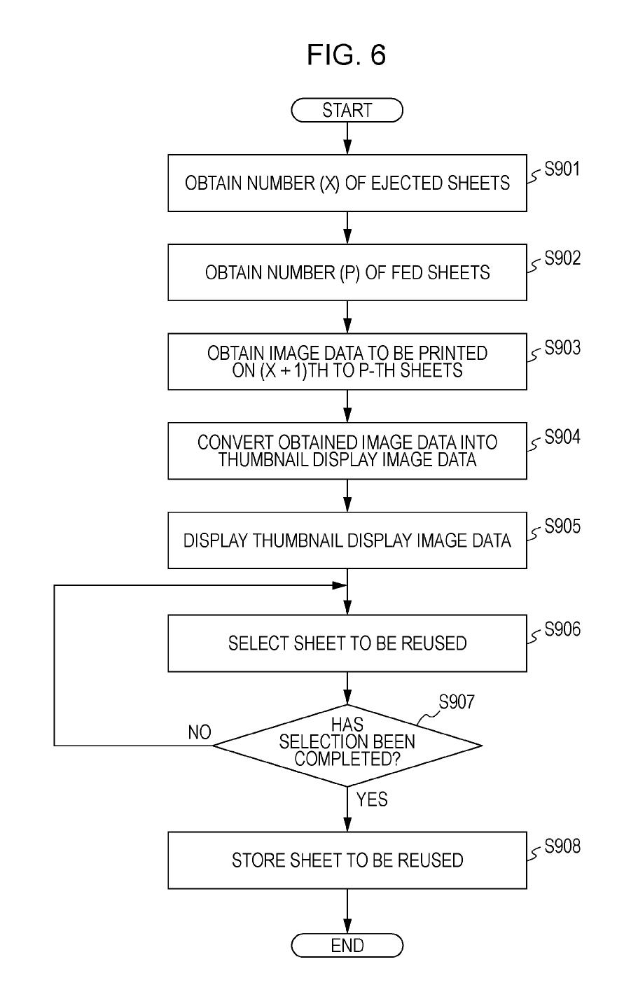

In S501, the control unit 201 prepares a variable P for storing the number of sheets fed from the sheet feeding unit in the RAM 206, and sets the value of P to an initial value 1. This value of P is used in the process shown in FIG. 6 (to be described later).

In S502, the control unit 201 identifies the sheet feeding unit to be used in accordance with job setting information. For example, in the job setting information, which is stored in the HDD 308, in a case where a specific sheet feeding unit is specified, the control unit 201 identifies the specified sheet feeding unit as a sheet feeding unit to be used. For example, in a case where the sheet feeding cassette 317 has been set to be used, the control unit 201 identifies the sheet feeding cassette 317 as a sheet feeding unit to be used.

There is a case in which, as the job setting information, a specific sheet feeding unit has not been specified, and the size of the paper sheet to be used for a printing process has been specified. In such a case, the control unit 201 identifies a sheet feeding unit, in which paper sheets of the specified size have been set, among a plurality of sheet feeding units provided in the printing system.

In S503, the control unit 201 feeds a sheet from the sheet feeding unit that has been identified in the manner described above, and causes the printer unit 207 to perform printing. The sheet on which an image has been printed is ejected onto a takeout outlet 331 of the starching bookbinding machine 200a, the accumulation unit 334 of the large capacity stacker, etc., in accordance with the setting for a post-process. Here, for the convenience of description, a job in which a plurality of sheets having an image printed thereon will be ejected onto the paper ejection unit 337 will be described as a typical operation example.

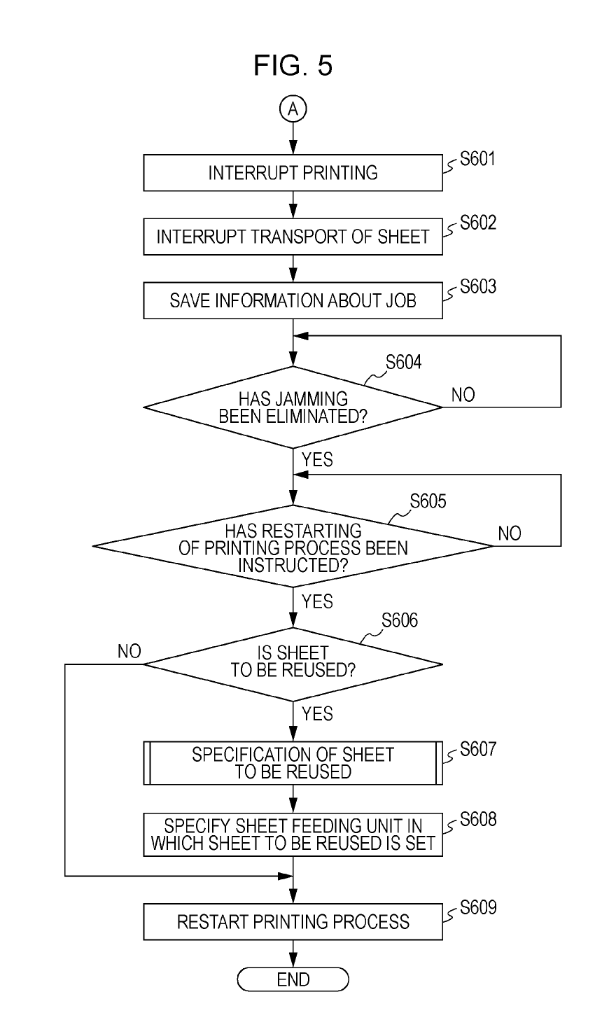

In S504, the control unit 201 determines whether or not jamming has occurred. When it is determined that the jamming has occurred, the process proceeds to A, and when otherwise, the process proceeds to S505. When the process proceeds to A, the control unit 201 performs a process shown in FIG. 5.

When jamming has not occurred, the control unit 201 determines in S505 whether or not a printing process for one copy, which is processed by performing a job, has been completed. For example, the control unit 201 determines whether or not all the plurality of sheets corresponding to one copy have been printed with images and are ejected onto the paper ejection unit 337. More specifically, first, the control unit 201 calculates how many sheets per copy are ejected when all the image data contained in the job is printed by the printer unit 207, and stores the number in the RAM 206. For example, regarding the job shown in FIG. 14, when one-side printing is performed without making a reduced layout, five sheets are ejected. Therefore, after the control unit 201 starts the printing of the job, the control unit 201 counts a signal from the sensor (for example, the sensor N) of the paper ejection unit, and determines whether or not five sheets have been ejected. In the manner described above, the control unit 201 determines whether or not all the plurality of the sheets corresponding to one copy have been printed with images, and have been ejected onto the paper ejection unit 337. Then, when the images for one copy have been printed on the sheets and these have not been ejected, the process proceeds to S506, where the value of 1 is added to a variable P, and the printing operation of S503 is further continued. On the other hand, when the images for one copy have been printed on the sheets and these have been ejected, it is determined that the printing process for one copy has been completed, and the process shown in the flowchart of FIG. 4 is completed.

When the process shown in the flowchart of FIG. 4 is completed, the process proceeds to S403 of FIG. 3. Then, S402 and S403 of FIG. 3 are repeated, so that a printing process for the number of copies, which is set in the job, is performed. When the job is structured as shown in FIG. 14, the control unit 201 performs a printing process for two copies.

As described above, the control unit 201 controls the execution of the printing operation. While the execution of the printing operation is being controlled, the control unit 201 manages which sheet feeding unit the sheet has been fed from, how many sheets have been fed, and how many sheets have been ejected, in the RAM 206 on the basis of the signals from the sheet detection sensors A to O. For example, while the control unit 201 is controlling the execution of the printing operation, the control unit 201 counts the number of sheets that pass through each sensor and stores the number.

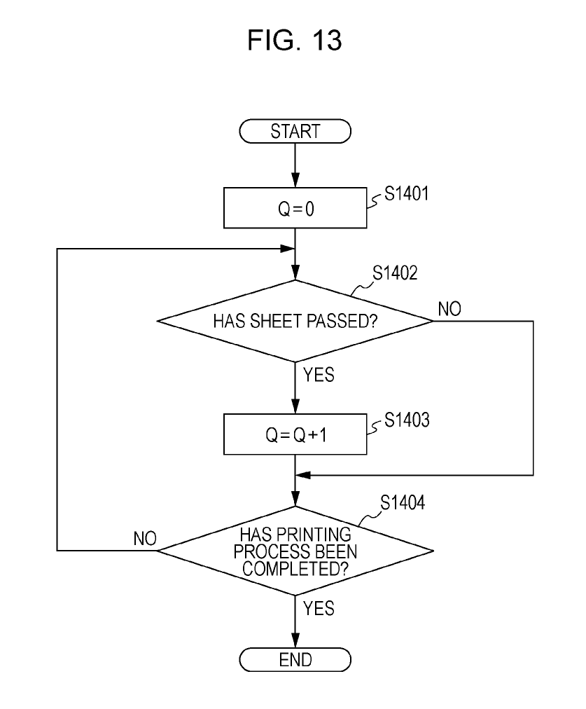

The flowchart shown in FIG. 13 shows a processing procedure in which the control unit 201 counts the number of sheets that pass through on the basis of the signal from each of the sheet detection sensors A to O. The flowchart shown in FIG. 13 is performed by reading and executing a program in the ROM 205 by the microcomputer of the control unit 201.

In S1401 shown in FIG. 13, the control unit 201 sets an initial value 1 to a variable Q. The variable Q is a variable for counting the number of sheets that pass through a certain sheet detection sensor. The variable Q is prepared as QA to QN for the sensors A to N, respectively, in a predetermined area of the RAM 206. The control unit 201 counts the number of sheets that pass through each sensor independently of each other, and separately stores the numbers in QA to QN, correspondingly. As a result, the control unit 201 knows the number of sheets that pass through each of the sensors A to N.

Next, in S1402, the control unit 201 determines whether or not a signal indicating that a sheet has passed through (the trailing end of the sheet has passed through) has been received from the sheet detection sensor. When a signal indicating that a sheet has passed through has not been received, the process proceeds to S1404, and when otherwise, the process proceeds to S1403. In S1403, the control unit 201 increases the value of Q by 1, and the process proceeds to S1404. The control unit 201 determines in step S1404 whether or not the printing process corresponding to the job has been completed. For example, in a case where the control unit 201 calculates in advance the number of sheets that are ejected as a result of performing the job and detects that all the sheets have been ejected by using the sheet detection sensor N of the paper ejection unit, the control unit 201 determines that the job has been completed. That is, when the value Q obtained by the counting in accordance with a signal from the sensor N of the paper ejection unit becomes the same value as the number of all the sheets that are ejected as a result of the execution of the target job, the control unit 201 determines that the job has been completed. Then, when the control unit 201 determines that the printing process has been completed, the processing is completed, and when otherwise, the process proceeds to S1402.

The control unit 201 performs such a process for each of the sheet detection sensors A to O. Then, it is possible for the control unit 201 to identify the number of sheets that have passed through each sheet detection sensor. Regarding the sheet detection sensor A of the sheet feeding unit, as described above, the sheet detection sensors A-1 to A-4 are provided in the sheet feeding units correspondingly. Then, the control unit 201 identifies how many sheets have been fed from each sheet feeding unit in accordance with signals from the sheet detection sensors A-1 to A-4. Furthermore, it is possible for the control unit 201 to identify how many sheets have been ejected onto the paper ejection tray 337 on the basis of the signal from the sheet detection sensor N.

In a case where jamming occurs in the sheet transport path while the control unit 201 is controlling the execution of the printing operation, the control unit 201 stops the printing process so as to interrupt the transport of the sheet. This makes it possible to prevent the jamming situation from becoming worse. Furthermore, the control unit 201 notifies the user of the fact that jamming has occurred, and also detects where inside the printing system 1000 the sheet exists on the basis of the signal of the sheet detection sensor, and displays the detection result on the operation unit 203.

When the printing process is stopped, the user confirms where inside the printing system 1000 the sheet exists via the display unit of the operation unit 203, and removes the sheet that exists in the sheet transport path. At this time, the jammed sheet and a sheet other than that exist in the sheet transport path.

Normally, since the jammed sheet is folded in the sheet transport path or is wrinkled, the jammed sheet cannot be handled as normally printed matter.

However, among sheets other than the jammed sheet, there is a sheet that does not get wrinkles or folded and that can be handled as normally printed matter if the user cautiously removes the sheet.

Although such a sheet can be handled as normal printed matter, hitherto, the user used to discard the jammed sheet and the subsequent sheets by considering them to be unneeded sheets. In that case, in order to reprint the image printed on the discarded sheet, the image is printed on a new sheet by using new toner, and the sheet and the toner are wasted. In particular, a large printing apparatus to which a post-processing device is connected has a long sheet transport path and thus, there is a possibility that when jamming occurs, many sheets remain in the sheet transport path, and the sheets that can be handled as normal printed matter during the jamming process are discarded in large amounts.

In recent years, printing operators receive special paper sheets, such as preprint paper, and image data from a customer, and prints images by using the preprint paper received from the customer. However, since only a limited number of sheets of preprint paper are received from the customer, wastefully discarding them is undesirable.

Accordingly, the present embodiment provides a scheme in which, when jamming occurs, a reusable sheet, which exists in the sheet transport path, is reused as much as possible with an easy operation.

In order to provide such a scheme, the processing procedure performed by the control unit 201 will be described with reference to FIG. 5.

FIG. 5 is a flowchart showing processing performed by the control unit 201 in a case where jamming occurs in the middle of the printing process described with reference to FIGS. 3 and 4. Each step of the flowchart shown in FIG. 5 is realized by reading and executing a program stored in the ROM 205 by the microcomputer of the control unit 201.

In S504 of FIG. 4, when the control unit 201 detects that jamming has occurred in the sheet transport path, the control unit 201 interrupts the printing by the printer unit 203 in S601, and interrupts the transport of the sheet in S602.

In S603, the control unit 201 saves the information on the job that is being performed, which is stored in the HDD 209, in the RAM 206 for the purpose of restarting the printing process later. That is, the control unit 201 stores the information for identifying the job that is being performed, information about which sheet feeding unit which sequential position of sheet has been fed from as a result of performing the job, and other information. These items of information about the interrupted job are used by the control unit 201 when the printing process is restarted.

In S604, the control unit 201 determines whether or not the jamming has been eliminated on the basis of the information from the sheet detection sensor of the sheet transport path. For example, when, as a result of the removal of the sheet by the user, the signal indicating that a sheet exists is no longer received from the sheet detection sensor from which occurrence of jamming has been detected, the control unit 201 determines that the jamming has been eliminated. The process does not proceed to S605 until it is determined that this jamming has been eliminated. When it is determined that the jamming has been eliminated, the process proceeds to S605.

In S605, the control unit 201 determines whether or not the restarting of the printing process has been instructed. The restarting of the printing process is instructed by the user via the operation unit 203. Alternatively, in response to that it is detected that all the doors of each device contained in the printing system 1000 have been closed, the control unit 201 may determine that the jamming process by the user has been completed and the restarting of the printing process has been instructed.

In S606, the control unit 201 determines whether or not the printing system 1000 has been set in such a manner that a sheet in the sheet transport path is reused. The setting should be set in advance via the operation unit 203 by the user, and the set content is stored in advance in the HDD 208. Rather than setting in advance via the operation unit 203 by the user, the user may make a selection as to whether or not the sheet is reused via the operation unit 203 at the timing of S606.

When the sheet has not been set to be reused, the process proceeds to S609. When otherwise, the process proceeds to S607.

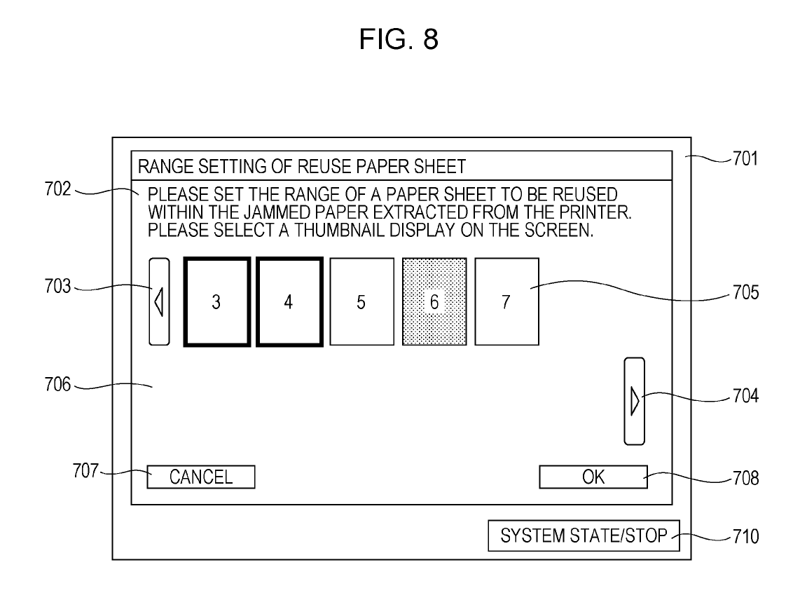

In S607, the control unit 201 accepts the specification of one or more sheets to be reused. For example, the control unit 201 causes the operation unit 203 to display a screen shown in FIG. 8, and accepts the specification of the sheet to be reused from the user via the screen. The detailed process in S607 will be described later with reference to the flowchart shown in FIG. 6.

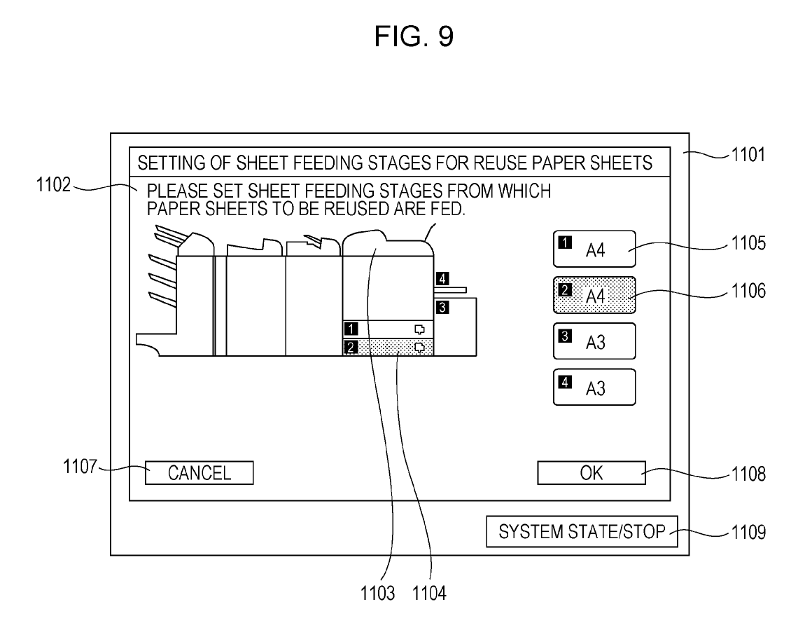

Next, in S608, the control unit 201 accepts the specification of the sheet feeding unit in which sheets to be reused are set. For example, the operation unit 203 is caused to display the screen shown in FIG. 9, so that the specification of the sheet feeding unit in which sheets to be reused are set is accepted from the user via the screen. The control unit 201 stores the accepted setting in the HDD 208. Here, the sheet feeding unit that can be specified by the user is limited to a sheet feeding unit differing from the sheet feeding unit used in the job that was interrupted as a result of the occurrence of the jamming. The reason for this is that, when restarting the interrupted job, if a sheet to be reused is set in the sheet feeding unit used for the relevant job, image data might be printed once more on the sheet on which the image data has been once printed. Here, the control unit 201 performs control so that a button corresponding to the sheet feeding unit that has been limited so as not to be capable of being selected is grayed out on the screen shown in FIG. 9. As a result, it is possible for the user to easily identify the sheet feeding unit that cannot be selected.

The user specifies the sheet feeding unit in which sheets to be reused by the operation unit 203 are set, and thereafter sets the sheets to be reused in the specified sheet feeding stage.

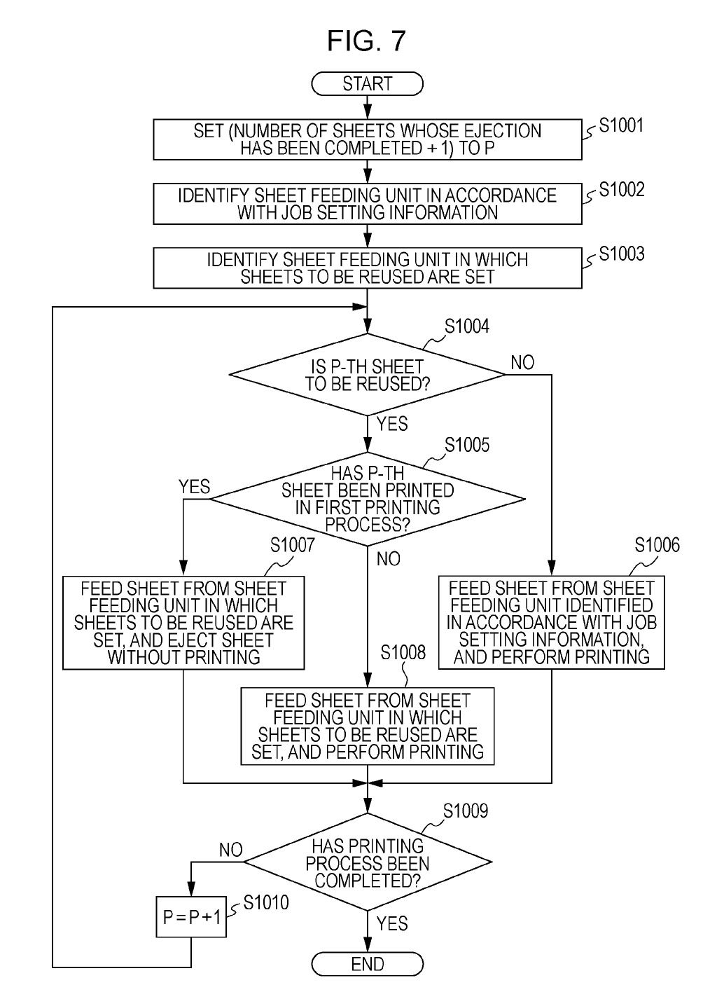

In S609, the control unit 201 restarts the printing process in accordance with the accepted specification. The restarting of the printing process will be described later with reference to FIG. 7.

The flowchart shown in FIG. 6 specifically illustrates the process of S607. Each step of the flowchart shown in FIG. 6 is realized by reading and executing a program stored in the ROM 205 by the microcomputer of the control unit 201.

Initially, in S901, the control unit 201 obtains the number (X) of sheets of the ejected sheets from the RAM 206. This is a value that has been counted by the control unit 201 on the basis of the signal from the paper ejection sensor N provided in the paper ejection unit 337.

Next, in S902, the control unit 201 obtains the number P of sheets (FIG. 4) of the fed sheets from the RAM 206.

In S903, the control unit 201 obtains image data that is printed on X+1 to P sheets within the image data corresponding to the job, which is stored in the HDD 209. In a case where an image for one page is to be printed on one sheet, the control unit 201 obtains image data for one page per sheet. Furthermore, in a case where an image for M (M is an integer) pages is to be printed on one sheet, the control unit 201 obtains image data for M pages per sheet.

In S904, the control unit 201 converts the obtained image data into thumbnail image data for making a thumbnail display by the image data processing unit 204 and stores the data in the HDD 208. For example, thumbnail image data is generated by reducing the document image data or by decreasing the resolution.

In S905, on the basis of the generated thumbnail image data, the control unit 201 causes the operation unit 203 to display thumbnail images.

That is, the control unit 201 displays a screen such as that shown in FIG. 8 on the operation unit 203. Then, in S906, the control unit 201 accepts a selection of sheets to be reused via the displayed screen.

A screen 701 shown in FIG. 8 includes a message area 702, scroll buttons 703 and 704, a sheet selection button 705, a sheet display area 706, a cancel button 707, an OK button 708, and a system situation button 710.

In the sheet display area 706, an image based on the thumbnail image data generated in S903 is displayed for each sheet. The control unit 201 accepts the specification of the sheet from the user via the screen. It is possible for the user to specify a sheet to be reused while viewing the image printed on each sheet.

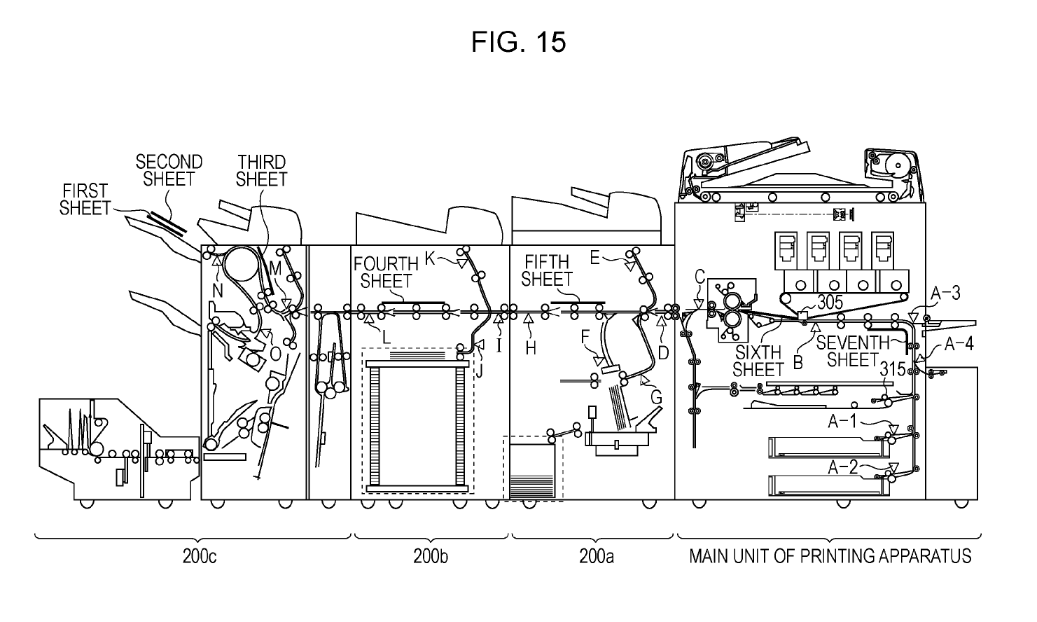

On the screen shown in FIG. 8, images of third to seventh sheets are displayed. This is a screen that is displayed in a case where jamming has occurred in the state of the sheet shown in FIG. 15. In this example, before the printing (job) is interrupted due to occurrence of jamming, one to seven sheets have already been fed. However, since the first and second sheets have been normally ejected, the control unit 201 performs control so that the images of these sheets are not displayed on the screen shown in FIG. 8. As a result, the first and second sheets are not selected by the user, so that the sheet that has been normally ejected once is prevented from being selected as a sheet to be reused.

By operating the sheet selection button 705 by using the displayed screen, the user specifies the sheet desired to be reused from among the sheets that have been fed before the printing (job) was interrupted. For example, in order to release the jamming, the user visually confirms a sheet without wrinkles or folds from among the sheets removed from the device, and specifies the sheet without wrinkles or folds as a sheet desired to be reused. This screen shows a state in which the third and fourth sheets have been specified. It is recommended that the images of the specified sheets are highlighted in such a manner that the contour thereof is darkly displayed, as shown in FIG. 8.

The sixth sheet shown in FIG. 8 is displayed in such a manner as to be grayed out so it cannot be selected. Such a display is made when, as shown in FIG. 15, the sixth sheet is in a state after an image is transferred thereto by the intermediate transfer belt 305 and before the image is fixed by the fixing unit 308. The reason why such a sheet cannot be selected is that the transferred toner has not yet been fixed and may be dispersed, and thus, the sheet cannot be reused. If such a sheet is set in the sheet feeding stage so that the user may reuse it, there is the risk of another sheet becoming stained with toner that has not yet been fixed. In the present embodiment, in order to prevent such a situation, the control unit 201 performs control so that a sheet after being transferred and before being fixed cannot be selected as a sheet to be reused. When jamming has occurred in a state in which the value of the sensor B indicates that five sheets have passed and the value of the sensor C indicates that four sheets have passed, the control unit 201 determines that the fifth sheet cannot be reused and makes such a display.

In S907, the control unit 201 determines whether or not the specification has been completed on the basis of whether or not the OK button 708 has been pressed by the user. When the control unit 201 determines that the specification has not been completed, the process returns to S906, and when otherwise, the process proceeds to S907.

In S908, the control unit 201 stores, in the RAM 206, the information indicating the sheet for which reuse has been specified. Then, the process proceeds to S608 of FIG. 5.

FIG. 7 is a processing procedure showing a printing process that is restarted in S809 of FIG. 5. Each step of the flowchart shown in FIG. 7 is realized by reading and executing a program stored in the ROM 205 by the microcomputer of the control unit 201. In the first embodiment, a description will be given of a case in which printing is restarted from the sheet whose paper ejection has not been completed among the sheets corresponding to the job that was interrupted due to the jamming.

In S1001, the control unit 201 sets, to the variable P, a value such that 1 is added to the number of sheets of the sheets whose ejection has been completed. This is for the purpose of performing sheet feeding starting from next to the sheet that has been normally ejected. For example, in a case where two sheets have been completed before jamming occurs, this is for the purpose of starting sheet feeding from the third sheet.

In S1002, the control unit 201 identifies the sheet feeding unit that serves as the sheet feeding source of sheets to be reprinted in accordance with the setting information of the interrupted job, which is saved in the HDD 308 in S603. For example, in a case where a specific sheet feeding unit has been specified in accordance with the job setting information, the control unit 201 identifies the specified sheet feeding unit as a sheet feeding unit for the sheet to be reprinted. For example, in a case where the sheet feeding cassette 317 has been set so as to be used, the control unit 201 identifies the sheet feeding cassette 317 as the sheet feeding unit for the sheet to be reprinted.

Furthermore, there is a case in which a specific sheet feeding unit has not been specified as the job setting information, and the size of the paper sheet used for a printing process has been specified. In such a case, the control unit 201 identifies the sheet feeding unit in which paper sheets of the specified size have been set among the plurality of sheet feeding units provided in the printing system.

In S1003, the control unit 201 identifies the sheet feeding unit in which sheets to be reused have been set by the user in accordance with the information on the sheet feeding unit selected in S608.

In S1004, the control unit 201 determines whether or not the P-th sheet is a sheet that has been specified so as to be reused. When the control unit 201 determines that the sheet has been specified so as to be reused, the process proceeds to S1005, and when otherwise, the process proceeds to S1006.

In S1005, the control unit 201 determines whether or not the P-th sheet has been printed in the first printing process shown in FIG. 4. The reason for this is that examples of sheets printed in the first printing process in S1005 include printed sheets that have been fixed by the fixing unit 308 has been completed. On the other hand, examples of sheets that have not been printed in the first printing process include sheets to which an image has not been transferred at the secondary transfer position 316. The sheet before fixing by the fixing unit 308 and after an image is transferred by the intermediate transfer belt 305 cannot be specified as a sheet to be reused, and therefore, the sheet is eliminated from the determination target in S1005. Then, the printed sheet does not need to be printed once more at the time of the reprinting process shown in FIG. 7. On the other hand, the sheet that has not yet been printed needs to be printed at the time of the reprinting process shown in FIG. 7.

In order to determine whether or not reprinting should be performed on a sheet to be reused, the control unit 201 determines in S1005 whether or not the fed sheet is a sheet that has already been printed by the first printing process in FIG. 4. The control unit 201 counts how many sheets have passed through the fixing unit 308 in the first printing process on the basis of the signal from the sheet detection sensor C provided in the paper ejection opening of the fixing unit 308, and stores the number in the RAM 206. Then, if the fed sheet is a sheet that passed through the fixing unit 308, the control unit 201 determines that the sheet is a printed sheet, and when otherwise, the control unit 201 determines that the sheet is a sheet that has not yet been printed. If the fed sheet is a printed sheet, the process proceeds to S1007, where the control unit 201 performs control so that the sheet is fed from the sheet feeding unit selected in S608 without transferring the image once more by the intermediate transfer belt 305, and the sheet is transported and ejected onto the paper ejection unit 337. Furthermore, the control unit 201 separates the heating rollers and the pressing rollers of the fixing unit 308 from each other while this sheet passes through the fixing unit 308. As a result, the sheet that does not need to be fixed can be prevented from being broken or bent as a result of a fixing process being performed thereon once more by the fixing unit 308. On the other hand, if the fed sheet is a not-yet printed sheet, the process proceeds to S1008, where the control unit 201 prints an image on the sheet and ejects the sheet onto the paper ejection unit 337.

In a case where the process proceeds to S1006, the control unit 201 feeds the P-th sheet from the sheet feeding unit indicated in accordance with the job setting information, which is specified in S1002, and printing is performed.

The control unit 201 determines in S1009 whether or not the printing process has been completed. When it is determined that the printing process has not been completed, the process proceeds to S1010.

In S1010, the control unit 201 increments P, and the process returns to S1004.

Then, the processing indicated by S1004 to S1008 is repeated for the number of sheets that should be printed. After that, When it is determined in S1009 that the printing process has been completed, the processing is completed. The method for determining in S1009 whether or not the printing process has been completed is identical to that of S505, and accordingly, repeated description thereof is omitted.

As described above, by restarting the printing, it is possible for the control unit 201 to insert the sheet to be reused at an appropriate position of the sheet to be reprinted.

By performing the control that has been described above, when restarting the printing process that was interrupted, it is possible to reuse the normally printed sheet.

Furthermore, in that case, it is possible for the user to specify the sheet desired to be reused by the user. Then, on the screen for selecting a sheet to be reused, normally ejected sheets are not displayed as selection candidates, and only the sheets remaining in the sheet transport path are displayed. Consequently, it is possible to prevent the user from becoming confused, and it becomes easier to select a sheet to be reused.

### Second Embodiment

In the first embodiment, a case has been described in which reprinting is performed starting from next to the sheet that has been normally ejected in the first printing process. In the second embodiment, a case will be described in which all the fed sheets are displayed on the display unit, and when a sheet to be reused is selected by the user, reprinting is performed from the beginning sheet by using the sheets to be reused. As a result of performing reprinting from the beginning sheet, in a case where a printing job is interrupted due to jamming and thereafter the printing process is restarted, the present invention can be applied even when printing is restarted from the beginning sheet.

The configuration of the printing apparatus in the second embodiment is the same as that of the first embodiment, and accordingly, detailed description thereof is omitted. Furthermore, the procedure of the printing process is the same as that shown in FIGS. 3 and 4, and the processing procedure performed when jamming occurs is the same as that described with reference to FIG. 5, and accordingly, detailed descriptions thereof are omitted.

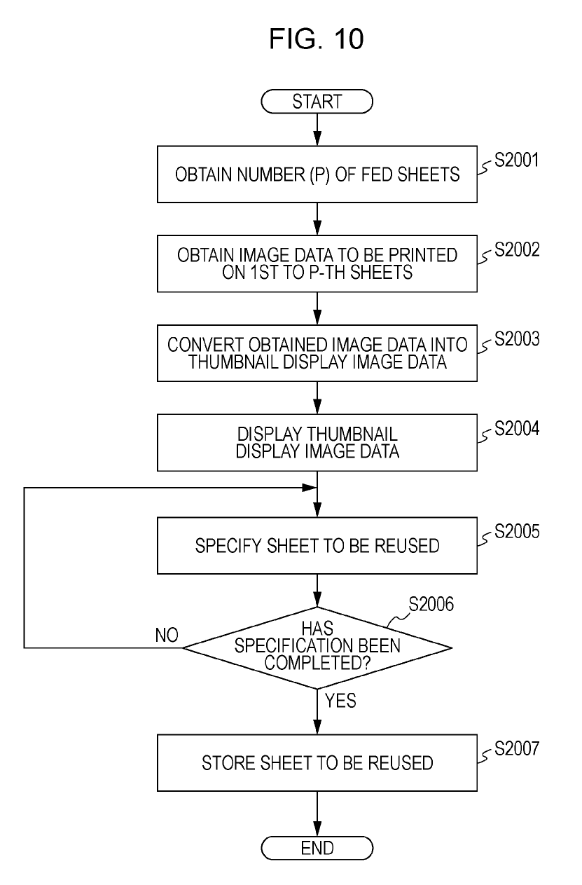

The difference of the second embodiment from the first embodiment is a method of restarting a printing process and lies in that the control unit 201 performs the process shown in FIG. 10 in place of the process shown in FIG. 6. In the second embodiment, a description will be given of a case in which a printing process that was interrupted due to jamming is restarted from the printing process for the beginning sheet.

The flowchart shown in FIG. 10 specifically illustrates the process of S607. Each step of the flowchart shown in FIG. 10 is realized by reading and executing a program stored in the ROM 205 by the control unit 201.

In S2001, the control unit 201 obtains the number (P) of fed sheets from the RAM 206.

In S2002, the control unit 201 obtains image data to be printed on X+1-th to P-th sheets within the image data corresponding to the job stored in the HDD 209.

In S2003, the control unit 201 converts the obtained image data into thumbnail image data for making a thumbnail display by the image data processing unit 204. For example, the thumbnail image data is generated by reducing the original image data or by decreasing the resolution.

In S2004, the control unit 201 causes the generated thumbnail image data to be displayed on the operation unit 203.

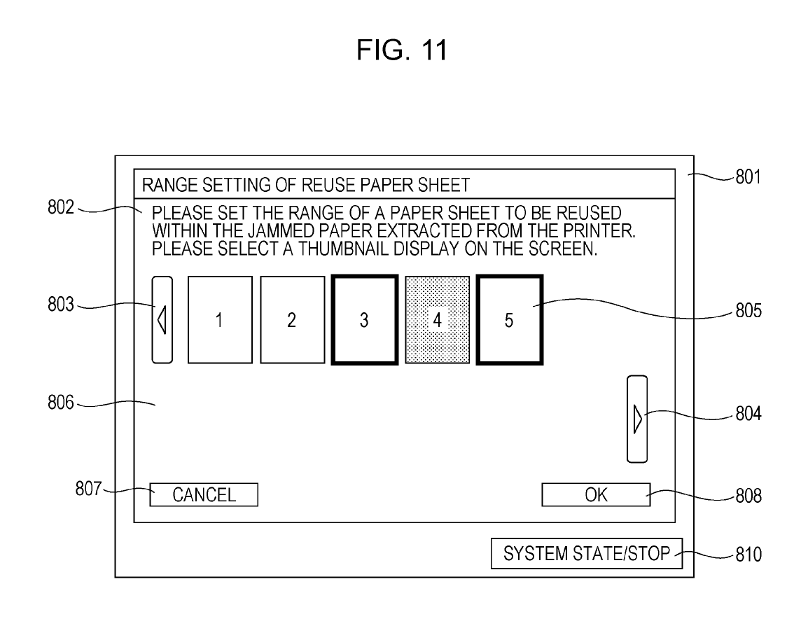

In S2005, the control unit 201 displays the screen such as that shown in FIG. 11 on the operation unit 203. Then, the control unit 201 accepts the selection of a sheet to be reused via the displayed screen.

The screen 801 shown in FIG. 11 has a message area 802, scroll buttons 803 and 804, a sheet selection button 805, a sheet display area 806, a cancel button 807, an OK button 808, and a system situation button 810.

In the sheet display area 806, images of sheets on which images are overlaid based on the thumbnail image data generated in S2004 are displayed. Here, regarding the displayed images of the sheets, unlike in the case of the first embodiment, the ejected sheets 1 and 2 are not displayed.

The control unit 201 accepts the selection of the sheet from the user via the screen. The user selects the image of the sheet indicating a sheet desired to be reused from within the displayed screen. For example, the user releases the jamming and thereafter selects the image of the sheet corresponding to the sheet with no wrinkles or folds. This screen shows a state in which third and fifth sheets have been selected. It is recommended that the images of the selected sheets are highlighted in such a manner that the contours thereof are displayed darkly, as shown in FIG. 11.

The fourth sheet shown in FIG. 11 is displayed in such a manner that the sheet is grayed out for the same reason as that in the case of the first embodiment so that the sheet cannot be selected.

In S2006, the control unit 201 determines whether or not the specification has been completed. When the control unit 201 determines that the selection has not been completed, the process returns to S2006, and when otherwise, the process proceeds to S2007.

In S2007, the control unit 201 stores the information indicating the selected sheet. Then, the process proceeds to S608 of FIG. 5.

After that, the method for restarting printing is almost the same as the process described with reference to FIG. 7. The page number at which printing is restarted is at page 1 of sheet. That is, 1 is set to P in S1001 of FIG. 7, and the printing process is restarted.

As described above, by restarting the printing, the control unit 201 is able to insert a sheet to be reused at an appropriate position of the sheet to be reprinted.

By performing control as described above, when restarting the interrupted printing process from the first sheet, it is possible to reuse the normally printed sheets.

In the second embodiment, an example has been described in which all the images of the sheets that are fed by the first printing process are displayed on the screen shown in FIG. 11. Alternatively, the number of displayed images of sheets may be limited. For example, by setting the number of displays in advance by the user, and by displaying the images of the sheets in accordance with the set number of displays, it is possible to prevent the generation of the displayed images of the sheets from taking a longer time in a case where the number of sheets that are fed in the first printing process is large.

### Third Embodiment

In the above-described first and second embodiments, descriptions have been given taking an example in which as a sheet that should not be reused, a sheet after toner is transferred to the sheet by the intermediate transfer belt 305 and before the toner is fixed by the fixing unit 308 is used. A jammed sheet may be displayed by using a similar scheme in such a manner that the sheet is assumed to be a sheet that should not be reused so that the user cannot select it. The control of the third embodiment is performed in addition to the control of the first embodiment or the second embodiment.

For example, in a case where a signal from a sheet detection sensor is continuously received for a predetermined time or more, the control unit 201 determines that jamming has occurred at a position corresponding to the sheet detection sensor. Furthermore, in a case where a sheet that has passed through a certain sheet detection sensor does not pass through the next sheet detection sensor for a predetermined time period, the control unit determines that jamming has occurred between those sheet detection sensors.

Next, the control unit 201 identifies the sequential position of the jammed sheet. For example, the control unit 201 counts the number of sheets that have passed through each sheet detection sensor. When jamming occurs, it is determined how many sheets the sensor that has detected that a sheet exists for a predetermined time or more has counted. For example, in the case where a signal indicating that a sheet exists for a predetermined time or more is received from the sheet detection sensor that completed the counting of one sheet, the control unit 201 determines the sheet in which the jamming has occurred to be a second sheet. Furthermore, in the case where a sheet that passed through the position corresponding to the sheet detection sensor that detects that two sheets have passed through does not reach the position corresponding to the next sheet detection sensor for a predetermined time period, the control unit 201 determines the jammed sheet to be a second sheet.

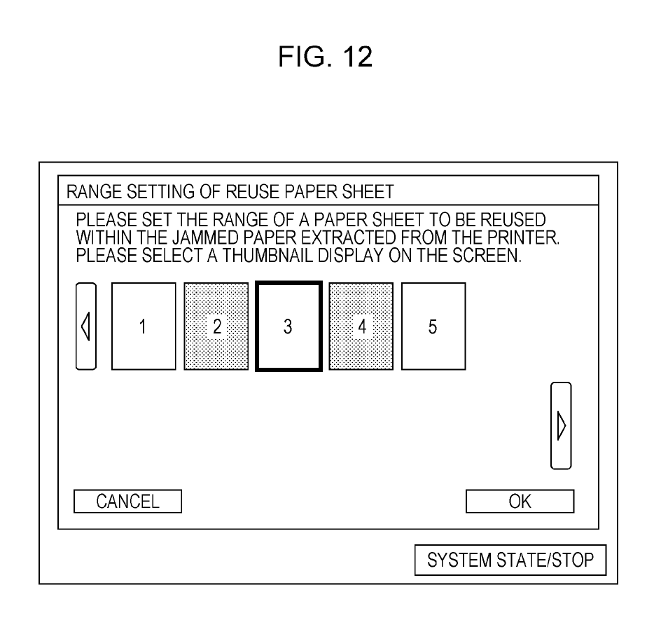

In such a method, in a case where the control unit 201 identifies the second sheet to be a sheet in which jamming has occurred, the control unit 201 displays the screen such as that shown in FIG. 12 in such a manner that the second sheet cannot be selected by the user. Since the fourth sheet shown in FIG. 12 is a sheet after transfer is performed and before fixing is performed, the fourth sheet is displayed in such a manner that it cannot be selected.

As a result, it is possible to prevent a sheet that should not be reused from being selected by mistake by the user and to prevent the sheet that should not be reused from being used in the case of reprinting.

In the present embodiment, an example has been described in which a sheet that cannot be reused is displayed in such a manner that the sheet cannot be selected. The present invention is not limited to this, and the sheet that cannot be reused may not be displayed.

This makes it possible to more effectively prevent a sheet that should not be reused from being specified by mistake by the user.

### Other Embodiments

In the above-described embodiments, an example has been described in which when restarting printing, a sheet that is reused is fed from a sheet feeding unit selected by the user. However, the present invention is not limited to this. As setting of the printing apparatus 100, which sheet feeding unit among a plurality of sheet feeding units should be used as the sheet feeding source for sheets to be reused is set in advance before jamming occurs. Then, the set sheet feeding unit may be used as a sheet feeding unit for reuse. Furthermore, sheets may be fed from the a fixed sheet feeding unit (for example, the manual bypass tray 319) without causing the user to perform setting.

In the above-described embodiments, there is a case in which there are a plurality of sizes, such as A4 and A3, for the sizes of sheets ejected by performing a job. In that case, in a case where jamming occurs and sheets of A4 and A3 are selected so that the user reuses the sheets, the control unit 201 may specify a sheet feeding unit for each size of the sheet. Furthermore, if types of sheets that are ejected as a result of performing a job include a plurality of types, such as plain paper and thick paper, and the user makes a selection in such a manner that sheets of plain paper and thick paper are reused, the control unit 201 may specify a sheet feeding unit for each type of the sheet. Then, when the user instructs the restarting of the printing process, the control unit 201 identifies the sheet feeding unit that is specified for each size and type of the sheet, feeds sheets to be reused from the identified sheet feeding unit, and outputs the sheets.

In the above-described embodiments, an example of specification control has been described in which a sheet that cannot be reused is displayed in such a manner as to be grayed out so that the sheet cannot be specified. The present invention is not limited to this, and a sheet that cannot be reused may not be displayed.

The above-described embodiments can also be applied to a case of an ink jet method rather than to an electrophotographic method in which the printing apparatus 100 transfers toner to a sheet and the transferred toner is fixed to the sheet. In a case where the printing apparatus 100 employs an ink jet method, in the case that a sheet having ink applied thereto has not passed through an image formation unit, such as an ink application unit, it may be determined that the sheet cannot be reused, and in the case that a sheet has passed through an image formation unit, such as an ink application unit, it may be determined that the sheet can be reused.

The object of the present invention can also be achieved by performing the following processing. That is, a storage medium having recorded thereon program code of software that realizes the functions of the above-described embodiments is supplied to a system or an apparatus, and the computer (or the CPU, the MPU, etc.) of the system or the apparatus reads the program code stored on the storage medium. In this case, the program code itself read from the storage medium realizes the functions of the above-described embodiments, and the program code and the storage medium having the program code stored thereon constitute the present invention.

### ADVANTAGEOUS EFFECTS OF INVENTION

According to the present invention, it is possible to reuse normally printed sheets when restarting a interrupted printing process.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. PCT/JP2009-070573, filed Dec. 8, 2009, which is hereby incorporated by reference herein in its entirety.

### REFERENCE SIGNS LIST

201 control unit
208 HDD

What is claimed is:

1. A printing apparatus that feeds a sheet from one feeding unit among a plurality of feeding units and that performs printing on the fed sheet, the apparatus comprising:
an interruption unit configured to interrupt printing when jamming of a sheet is detected;
a reprinting unit configured to, after printing is interrupted, perform reprinting on the sheet that is fed when restarting the printing;
a specification unit configured to, when the printing is interrupted, specify one or more sheets among the sheets that have been fed before the job was interrupted;
a selection unit configured to select a feeding unit among the plurality of feeding units, in which specified sheets are set so that the user reuses the sheets; and
a control unit configured to, when restarting the printing, perform control so that reprinting is not performed on the one or more specified sheets, the specified sheets being fed from the selected feeding unit and being output together with the sheet on which reprinting is performed.

2. The printing apparatus according to claim 1, wherein the control unit performs control so that the one or more specified sheets are inserted into the sheets on which reprinting is performed.

3. The printing apparatus according to claim 1, further comprising a display unit configured to, when the printing is interrupted, display an image indicating the sheet fed before the job is interrupted, and image data that is printed on the sheet in such as to be associated with each other,
wherein the specification unit specifies one or more sheets in accordance with an instruction from a user among the images indicating the displayed sheets.

4. The printing apparatus according to claim 1, further comprising a first specification control unit configured to perform control so that an image indicating a sheet that is ejected before the job is interrupted cannot be specified.

5. The printing apparatus according to claim 1, further comprising an image formation unit configured to form an image on a sheet, and
a second specification control unit configured to perform control so that a sheet on which an image has not been completely formed before the job is interrupted cannot be specified.

6. The printing apparatus according to claim 5, wherein the image formation unit includes a transfer unit for transferring toner to a sheet, and a fixing unit for fixing the transferred toner, and
wherein the second specification control unit performs control so that the sheet to which toner has been transferred and to which the toner has not been fixed before the job is interrupted cannot be specified.

7. The printing apparatus according to claim 1, further comprising an identification unit configured to identify a jammed sheet, and
a third specification control unit configured to perform control so that the sheet that has been identified before the job is interrupted cannot be specified.

8. A method of controlling a printing apparatus that feeds a sheet from one feeding unit among a plurality of feeding units and that performs printing on the fed sheet, the method comprising:
interrupting printing when jamming of a sheet is detected;
when restarting the printing after the printing is interrupted, performing reprinting on a sheet that is fed;
accepting specification of one or more sheets among the sheets that have been fed before the job was interrupted when the printing was interrupted;
selecting a feeding unit in which the one or more sheets are set so as to be reused by a user among the plurality of feeding units; and
performing control so that, when restarting the printing, reprinting is not performed on the one or more specified sheets, the specified sheets being fed from the selected feeding unit and being output together with the sheet on which reprinting is performed.

9. The method according to claim 8, further comprising performing control so that the one or more specified sheets are inserted into the sheets on which reprinting is performed.

10. The method according to claim 8, further comprising:
when the printing is interrupted, displaying an image indicating the sheet fed before the job is interrupted, and image data that is printed on the sheet in such as to be associated with each other; and
specifying one or more sheets in accordance with an instruction from a user among the images indicating the displayed sheets.

11. The method according to claim 8, further comprising performing control so that an image indicating a sheet that is ejected before the job is interrupted cannot be specified.

12. The method according to claim 8, further comprising:
forming an image on a sheet; and
performing control so that a sheet on which an image has not been completely formed before the job is interrupted cannot be specified.

13. The method according to claim 8, further comprising:
identifying a jammed sheet; and
performing control so that the sheet that has been identified before the job is interrupted cannot be specified.

14. A computer readable storage medium storing a computer-executable program for causing a computer to perform the method according to claim 8.

15. The computer readable storage medium according to claim 14, further comprising performing control so that the one or more specified sheets are inserted into the sheets on which reprinting is performed.

16. The computer readable storage medium according to claim 14, further comprising:
when the printing is interrupted, displaying an image indicating the sheet fed before the job is interrupted, and image data that is printed on the sheet in such as to be associated with each other; and
specifying one or more sheets in accordance with an instruction from a user among the images indicating the displayed sheets.

17. The computer readable storage medium according to claim 14, further comprising performing control so that an image indicating a sheet that is ejected before the job is interrupted cannot be specified.

18. The computer readable storage medium according to claim 14, further comprising:
forming an image on a sheet; and
performing control so that a sheet on which an image has not been completely formed before the job is interrupted cannot be specified.

19. The computer readable storage medium according to claim 14, further comprising:
identifying a jammed sheet; and
performing control so that the sheet that is identified before the job is interrupted cannot be specified.
